(19) United States
(12) Patent Application Publication
(10) Pub. No.: US 2020/0310188 A1
(43) Pub. Date: Oct. 1, 2020

(54) HOUSING AND DEVICE

(71) Applicant: SAKAI DISPLAY PRODUCTS CORPORATION, Sakai-shi, Osaka (JP)

(72) Inventor: Arimasa SUGIMOTO, Sakai-shi, Osaka (JP)

(73) Assignees: SAKAI DISPLAY PRODUCTS CORPORATION, Sakai-shi, Osaka (JP); SAKAI DISPLAY PRODUCTS CORPORATION, Sakai-shi, Osaka (JP)

(21) Appl. No.: 16/087,063

(22) PCT Filed: Mar. 23, 2016
(86) PCT No.: PCT/JP2016/059228

§ 371 Date: Jan. 17, 2019

(51) Int. Cl. G02F 1/1333

(52) U.S. Cl. CPC G02F 1/133308; G02F 2001/133314; G02F 2001/13332

(57) ABSTRACT

Provided is a technology capable of preventing damage to a flexible substrate during a front chassis assembling process. This housing comprises a first frame (40) and a second frame. The first frame (40) includes a rectangular bottom plate portion, and a side plate portion disposed along the outer periphery of the bottom plate portion and perpendicular to the bottom plate portion. The second frame includes a rectangular holding portion and a fixing portion having an outer surface that comes in contact with the inner surface of the side plate portion of the first frame (40). The first frame (40) is fitted onto the second frame such that the bottom plate portion of the first frame (40) faces the holding portion of the second frame. A notched portion (32) is formed at a distal end of the first frame (40) from the bottom plate portion in a first side plate portion (421) of the first frame (40). The notch depth of the notched portion (32) gradually increases from a distal position from a second side plate portion adjacent to the first side plate portion (421) toward a proximal position.

### TECHNICAL FIELD

The present invention relates to a housing and an apparatus.

### BACKGROUND ART

Some of display panels, which have a display surface including a region (image display region) for displaying an image (including video) and a peripheral region surrounding the image display region, have been provided with a flexible substrate which is provided on a side surface of the display panel and protrudes in a direction away from the image display region. The flexible substrate is bent in an assembled display apparatus.

A display apparatus has been described in which a soft protective member is provided on a frame that covers the peripheral region and the side surface of the display panel in order to prevent damage to the flexible substrate protruding from the display panel due to the flexible substrate coming into contact with or striking the frame (Patent Document No. 1).

### CITATION LIST

### Patent Literature

Patent Document No. 1: Japanese Laid-Open Patent Publication No. 2009-75337

### SUMMARY OF INVENTION

### Technical Problem

After a front chassis is positioned with respect to the display panel with the front chassis facing the display surface of the display panel, the front chassis is moved toward the display panel with these members kept parallel to each other, and the four sides of the front chassis are thereby simultaneously joined to the display panel. In such a case, the edge of the front chassis simultaneously pushes all flexible substrates, so that the flexible substrates are bent in a direction away from the display surface. However, in the case of a large-size display apparatus, it is difficult to simultaneously join the four sides of the front chassis to the display panel.

To address such a problem, the edge of the front chassis is pressed against one side surface of the display panel, and the front chassis is turned around the pressed edge of the front chassis as a pivotal axis so that the front chassis is moved toward the display panel, which makes it easier to join the front chassis to the display panel.

However, when the front chassis is turned, the front chassis comes into contact with or strikes the flexible substrate in a direction perpendicular to the pivotal axis. Therefore, the flexible substrate is likely to be damaged.

With this in mind, the present invention has been made. It is an object of the present invention to provide a technique capable of preventing damage to a flexible substrate in a step of joining a front chassis.

### Solution to Problem

A housing includes a first frame including a rectangular bottom plate portion, and side plate portions provided along an outer perimeter edge of the bottom plate portion and perpendicular to the bottom plate portion, and a second frame including a rectangular holding portion, and fixation portions each having an outer surface to abut outwardly with an inner surface of the corresponding one of the side plate portions of the first frame. The first frame is fitted onto the second frame with the bottom plate portion of the first frame facing the holding portion of the second frame. A first one of the side plate portions of the first frame has a notch formed at an edge of the first side plate portion farther from the bottom plate portion of the first frame. The notch has a notch depth increasing gradually in a direction from a far position toward a near position to a second one of the side plate portions adjacent to the first side plate portion.

### Advantageous Effects of Invention

With the present invention, damage to the flexible substrate can be prevented during the step of joining the front chassis.

### BRIEF DESCRIPTION OF DRAWINGS

FIG. 1 is an explanatory diagram showing a state of a display apparatus according to an embodiment of the present invention at some point during assembly thereof.

FIG. 2 is a side view of a front chassis in a housing according to an embodiment of the present invention.

FIG. 3 is an enlarged view of a portion A shown in FIG. 1.

FIG. 4 is an explanatory diagram showing a state of a display apparatus according to a comparative example at some point during assembly thereof.

### DESCRIPTION OF EMBODIMENTS

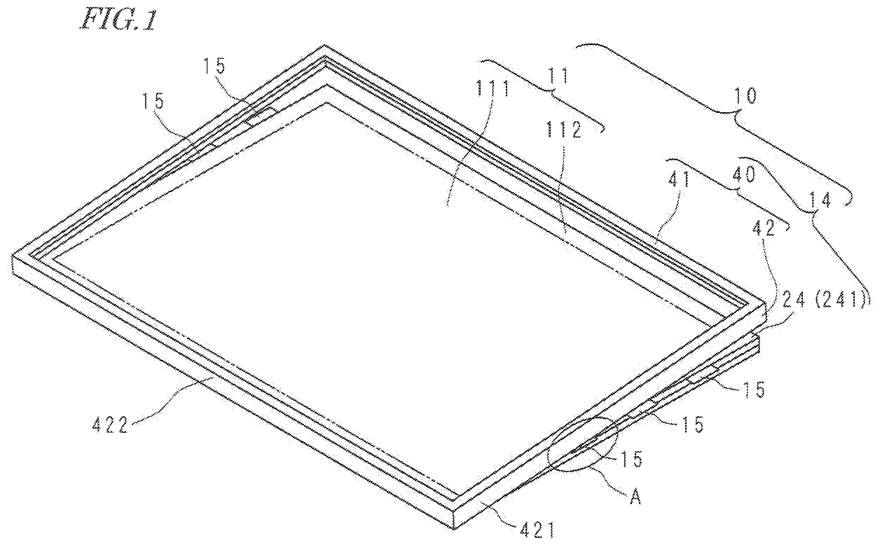

In the description that follows, reference signs shown in FIGS. 1-4 are used. Note that FIGS. 1-4 are described in detail below.

### First Embodiment

FIG. 1 is an explanatory diagram showing a state of a display apparatus 10 at some point during assembly thereof. The display apparatus 10 is an example of an apparatus. FIG. 1 shows a state at some point during a process of joining a front chassis 40 to a display panel 11 and a panel chassis 24.

As shown in FIG. 1, in the display apparatus (apparatus) 10 according to this embodiment, the front chassis (first frame) 40 and the panel chassis (second frame) 24 fitted onto the front chassis 40 together form a housing 14, in which the display panel 11 is held between the front chassis 40 and the panel chassis 24.

The display panel 11, which is in the shape of a rectangular parallelepiped, has an upper surface (display surface) facing the front chassis 40, a lower surface (light-receiving surface) parallel to the upper surface, and side surfaces (end surfaces) perpendicular to the upper surface. The light-receiving surface of the display panel 11 faces a frame portion (bottom plate portion) 41 of the front chassis 40. The end surfaces of the display panel 11 face respective side plate portions 42 of the first frame 40.

The frame portion 41 of the front chassis 40 is in the shape of a frame that has an opening through which a user views an image displayed on the display panel 11. The front chassis 40 has the frame portion 41, which has a rectangular outer perimeter, and the four side plate portions 42, which are perpendicular to the frame portion 41. The side plate portions 42 are arranged along an outer perimeter edge of the frame portion 41.

The display surface of the display panel 11 includes an image display region 111 that corresponds to the opening of the front chassis 40, and a peripheral region (peripheral portion) 112 that corresponds to the frame portion 41 of the front chassis 40 and surrounds the image display region 111. A flexible substrate (flexible film) 15 on which a driver circuit (not shown) is mounted is attached to the peripheral region 112 with a terminal (not shown) provided on the peripheral region 112 connected to a terminal (not shown) of the flexible substrate 15. A region of the flexible substrate 15 in which the driver circuit is mounted protrudes out of the display panel 11.

The display panel 11 is an example of an object that is housed in the product of the present invention. The display panel 11 may, for example, be a liquid crystal panel or an organic electroluminescent (EL) panel.

The flexible substrate 15 is an example of a flexible film that is used in the present invention. The flexible substrate 15 may, for example, be a chip-on-film (COF), which is an integrated circuit (e.g., a driver circuit for controlling drive of the display panel 11) mounted on a flexible film substrate. FIG. 1 shows a state in which a total of eight flexible substrates 15 protrude from opposite sides of the display panel 11 (i.e., four flexible substrates protruding from each side). The term “protrude” with respect to a flexible substrate means that the flexible substrate is disposed on a certain region and a portion of the flexible substrate extends out of that region.

The front chassis 40 is an example of a first frame used in the present invention. The front chassis 40 is preferably formed of a light-weight metal material (e.g., an aluminum alloy). The frame portion 41, which is an example of a bottom plate portion, is a rectangular frame that has substantially the same outer shape as that of the display panel 11, has an opening having the same shape as that of the image display region 111, and covers the peripheral region 112. The side plate portions 42 are disposed at the outer perimeter of the frame portion 41 and are perpendicular to the frame portion 41.

In the description that follows, a side plate portion 42 connected to a shorter side of the frame portion 41 is also referred to as a “first side plate portion 421.” A side plate portion 42 that is connected to a longer side of the frame portion 41 and is closer to the viewer of FIG. 1 is also referred to a “second side plate portion 422.”

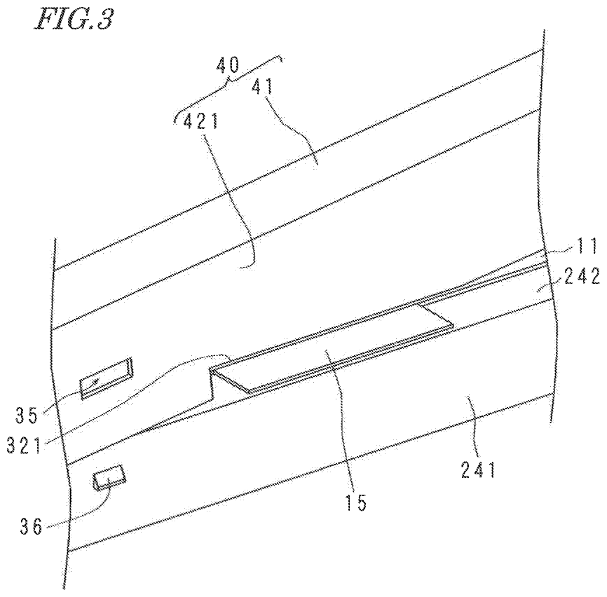

The panel chassis 24 is an example of a second frame used in the present invention. The panel chassis 24 is formed of, for example, a white synthetic resin. A holding portion 242 has substantially the same outer shape as that of the display panel 11. Fixation portions 241 are perpendicular to the holding portion 242, and are connected to the holding portion 242. A protrusion 36 (see FIG. 3) is provided on a fixation portion 241 adjoining a shorter side of the holding portion 242. The protrusion 36 is an example of a fixation assisting mechanism.

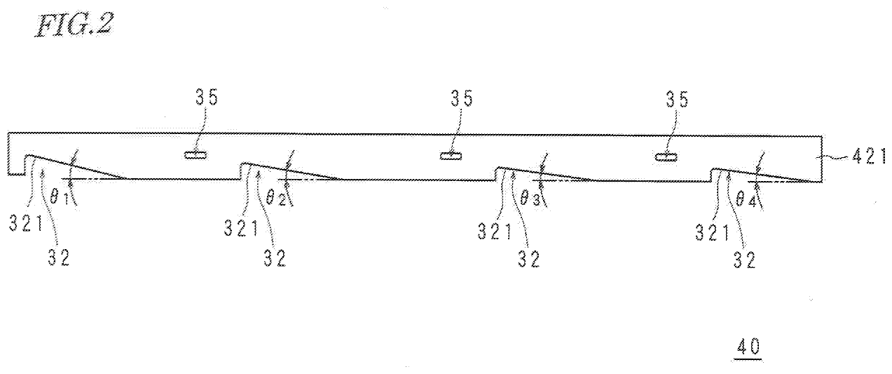

FIG. 2 is a side view of the front chassis 40. The first side plate portion 421 shown in FIG. 2 of the front chassis 40 has four notches 32, and through-holes 35 that are generally rectangular.

As shown in FIG. 2, in this embodiment, the notches 32, which are generally V-shaped, are provided at an edge of the first side plate portion 421 of the front chassis 40 that is farther from the frame portion 41. The notches 32 have a notch depth that increases gradually in one direction (in a direction from a farther end to a closer end with respect to the second side plate portion 422, which includes the above pivotal axis).

Slope angles of notch edges 321 are represented by θ1, θ2, θ3, and θ4, with the numbering starting from the leftmost notch 32 of FIG. 2.

The slope angles increase gradually in a direction from the leftmost notch 32 to the rightmost notch 32 of FIG. 3. That is, the slope angles satisfy expression (1).

θ1>θ2>θ3>θ4 (1)

Referring back to FIG. 1, a step of joining the front chassis 40 will be described. The display panel 11 is placed on the holding portion 242 of the panel chassis 24 with the display surface facing upward. The front chassis 40 is inclined and put onto the display panel 11 from above. The second side plate portion 422 is made contact with one of the longer sides of the display panel 11. The other longer side of the front chassis 40 is located above the other longer side of the display panel 11.

FIG. 1 shows a situation that the first side plate portion 421 comes into contact with or strikes a flexible substrate 15 at a portion A in the figure when the front chassis 40 is fitted onto the panel chassis 24 by turning the front chassis 40 around a fixation portion 241 of the panel chassis 24 that faces the second side plate portion 422, as a pivotal axis, with an edge of the second side plate portion 422 being in contact with that fixation portion 241.

FIG. 3 is an enlarged view of the portion A of FIG. 1. The description is continued with reference to FIGS. 1 and 3.

The side plate portion 42 is inclined and covers the fixation portion 241 of the panel chassis 24. When the front chassis 40 is fitted onto the panel chassis 24, the display panel 11 is interposed between the frame portion 41 and the holding portion 242 of the panel chassis 24. The fixation portion 241 is pressed against the side plate portions 42. Thus, the housing 14 including the front chassis 40 and the panel chassis 24 holds the display panel 11.

As shown in FIG. 3, the panel chassis 24 includes the rectangular holding portion 242 for holding the display panel 11, facing the frame portion 41 of the front chassis 40, and the fixation portion 241 having an outer surface that is to be overlaid by an inner surface of the side plate portion 42 of the front chassis 40. The holding portion 242 and the fixation portion 241 are connected together. Thus, the display panel 11 is sandwiched between the frame portion 41 of the front chassis 40 and the holding portion 242 of the panel chassis 24, with the fixation portion 241 of the panel chassis 24 pressed against the side plate portion 42 of the front chassis 40, whereby the display panel 11 is fixed to the front chassis 40 and the panel chassis 24.

The holding portion 242 of the panel chassis 24 is in the shape of a frame (not shown) having an opening through which light passes from the light source toward the display panel 11.

When an edge of one of the side plate portions 42 of the front chassis 40 is made contact with a fixation portion 241 of the panel chassis 24 facing that side plate portion 42, and the front chassis 40 is turned around that contact portion as a pivotal axis toward the panel chassis 24, the front chassis 40 can be fitted onto the panel chassis 24. However, due to such a movement, the flexible substrates 15 protruding out of the display panel 11 are likely to be cleaved, in a direction from a closer end toward a farther end thereof with respect to the pivotal axis, by the farther edge of the side plate portion 42 of the front chassis 40 perpendicular to the pivotal axis.

In this embodiment, as shown in FIG. 3, the slope angle of the notch edge 321 is such that the notch edge 321 and the flexible substrate 15 are substantially parallel to each other when the notch edge 321 and the flexible substrate 15 are close to each other.

After the state shown in FIG. 3, the front chassis 40 is further turned clockwise around the contact portion between the second side plate portion 422 and the panel chassis 24 as a pivotal axis. The other longer side of the front chassis 40 moves in a direction toward the display panel 11. The entire notch edge 321 comes into contact with or strikes the flexible substrate 15. When the front chassis 40 is further turned, the notch edge 321 pushes the flexible substrate 15, which is then bent. The flexible substrate 15 is tucked into a space between the front chassis 40 and the panel chassis 24.

With such a configuration, in this embodiment, when the front chassis 40 is turned in the above manner to be fitted onto the panel chassis 24, the notch edge 321 that defines the notch depth of the notch 32 comes in contact with or strikes the flexible substrate 15 protruding out of the display panel 11, substantially simultaneously across its length from the closer end to the farther end relative to the pivotal axis. In other words, contact or striking between the notch edge 321 and the end of the flexible substrate 15 closer to the pivotal axis, and contact or striking between the notch edge 321 and the end of the flexible substrate 15 farther to the pivotal axis, occur simultaneously.

Therefore, in this embodiment, it is possible to avoid the situation that a pressing force caused by the above turning is applied to a single point (particularly, the end closer to the pivotal axis) of the flexible substrate 15 protruding out of the display panel 11. As a result, the side plate portion 42 of the front chassis 40 can be prevented from cleaving the flexible substrate 15 from the father end to the closer end with respect to the pivotal axis.

As described above, the display panel 11 is fixed to the front chassis 40 and the panel chassis 24 with the fixation portion 241 of the panel chassis 24 pressed against the side plate portion 42 of the front chassis 40. In order to further enhance such fixation, the fixation assisting mechanism 36 that assists in fixing the side plate portion 42 of the front chassis 40 to the fixation portion 241 of the panel chassis 24, is preferably provided in a region where the flexible substrate 15 is not present (a region in which the fixation assisting mechanism 36 does not interfere with the flexible substrate 15). As shown in FIG. 3, the fixation assisting mechanism 36 may be provided on the fixation portion 241 of the panel chassis 24, as the protrusion 36 that is engaged with the through-hole 35 provided in the side plate portion 42 of the front chassis 40. The present invention is not limited to this. Alternatively, for example, the fixation assisting mechanism 36 may be provided in the form of a female screw that is screwed onto a male screw inserted through the through-hole 35 from the outer surface of the front chassis 40, or a female screw or recessed portion formed in the fixation portion 241 of the panel chassis 24 to which a projecting pin inserted through the through-hole 35 from the outer surface of the front chassis 40 is hooked. In view of this, the notches 32 of this embodiment are formed in a region in which the notches 32 do not interfere with the fixation assisting mechanism 36.

The protrusion 36 of FIG. 3 will be described. When the front chassis 40 is moved until the frame portion 41 and the peripheral region 112 come into contact with each other, the protrusion 36 that is provided in a region of the panel chassis 24 in which the protrusion 36 does not interfere with the flexible substrate 15, engages with the through-hole 35 that is provided at a position of the front chassis 40 corresponding to the protrusion 36, so that the front chassis 40 is fixed to the panel chassis 24. Note that the protrusion 36 is provided in a region in which the protrusion 36 does not interfere with the flexible substrate 15.

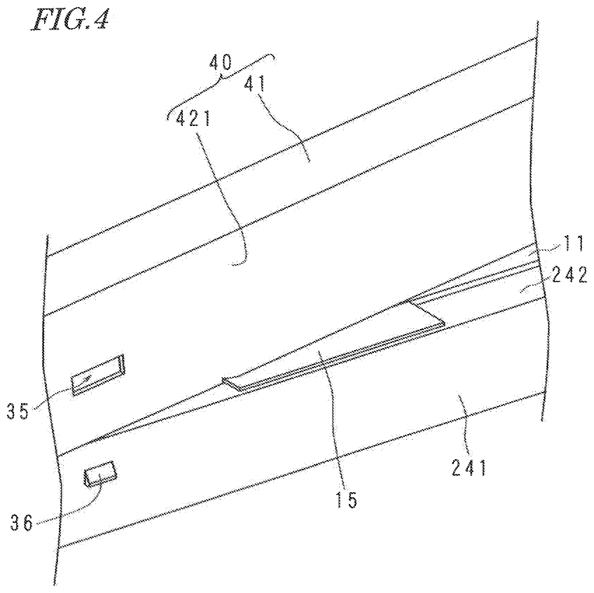

While FIG. 3 shows the configuration of the present invention that avoids the cleavage, FIG. 4 shows a configuration of a comparative example that cannot avoid the cleavage.

FIG. 4 is an explanatory diagram showing a state of a display apparatus according to a comparative example at some point during assembly thereof. In the comparative example, the notch 32 is not provided. FIG. 4 shows the same portion and assembly stage as those of FIG. 3. An effect of this embodiment will be described with reference to FIGS. 3 and 4.

As shown in FIG. 4, in the comparative example, the flexible substrate 15 and the front chassis 40 come into contact with or strikes each other at a single point. Therefore, shear force is applied to an end of the flexible substrate 15, and therefore, the flexible substrate 15 is likely to be cleaved. Even if the flexible substrate 15 is not cleaved, the flexible substrate 15 is twisted and thereby strained, so that a wiring pattern connecting the display panel 11 and the integrated circuit is likely to be broken.

In contrast, as shown in FIG. 3, in this embodiment, the entire notch edge 321 comes into uniform contact with the substrate 15 and presses the substrate 15. Therefore, the flexible substrate 15 is bent without being twisted or receiving shear force. Therefore, the display apparatus 10 can be provided in which damage to the flexible substrate 15 can be prevented during the step of joining the front chassis 40.

In the case where the display panel 11 is a transmissive liquid crystal display panel, the display surface of the display panel 11 including the image display region 111 is parallel to the light-receiving surface thereof, i.e., the back surface thereof. The panel chassis 24 is preferably in the shape of a rectangular frame having an opening having substantially the same shape as that of the image display region 111 at the center of the holding portion 242. A light source unit is disposed so as to face the light-receiving surface of the display panel 11, and functions as a backlight that illuminates the light-receiving surface of the display panel 11 through the opening provided in the panel chassis 24.

The number of the flexible substrates 15 is not limited to eight. The flexible substrate(s) 15 may be provided along only one of the shorter sides of the display panel 11.

The number of the flexible substrates 15 may not be equal to the number of the notches 32. For example, of the notches 32 of FIG. 3, two on the right side of the figure may be omitted. When the front chassis 40 is being fitted onto the panel chassis 24, a flexible substrate 15 located farther from the pivotal axis is more nearly parallel to the front chassis 40, and therefore, is less likely to be damaged, even in the absence of a notch 32.

The notch edge 321 and a surrounding portion may be covered with a soft adhesive tape, etc. This can prevent the front chassis 40 formed of a metal from directly touching the flexible substrate 15 and damaging the flexible substrate 15.

The side plate portion 42 may have a notch edge 321 that is formed by an edge thereof being folded.

In this embodiment, the notch(es) 32 may be formed according to the number and positions of the flexible substrates 15 attached to the display panel 11, and therefore, a plurality of notches 32 may be formed in the first side plate portion 421. In this case, the rate at which the above notch depth increases gradually becomes greater in the direction from the far position toward the near position with respect to the pivotal axis. In other words, the notch 32 that is closest to the pivotal axis has the greatest notch depth, and the notch 32 that is farthest from the pivotal axis has the smallest notch depth, where the notch depth is measured at the end of the notch 32 closer to the pivotal axis. In FIG. 2, assuming that the pivotal axis is present to the left of the figure, the leftmost notch 32 has the greatest notch depth, and the rightmost notch 32 has the smallest notch depth.

The first side plate portion 421 is herein intended to be a side plate portion 42 of the front chassis 40 in which the notch 32 is formed. Therefore, this embodiment encompasses an aspect that both of the side plate portions 42 that are perpendicular to the second side plate portion 422 including the pivotal axis serve as the first side plate portion 421. In this case, the shapes of the notches 32 formed in the two first side plate portions 421 are symmetrical with respect to a plane perpendicular to the second side plate portion 422.

In this embodiment, the driver circuit mounted on the flexible substrate 15 is tucked into a space between the side plate portion 42 (the inner surface of the side plate portion 42) of the front chassis 40 and the fixation portion 241 (the outer surface of the fixation portion 241) of the panel chassis 24. The outer surface of the fixation portion 241 of the panel chassis 24 preferably has a recessed region (not shown) facing the driver circuit. As a result, damage to the driver circuit can be avoided.

In this embodiment, the panel chassis 24 is illustrated as an example member of the housing 14 that is configured so as to avoid damage to the flexible substrate 15. As described above, the configuration with which damage to the flexible substrate 15 due to the front chassis 40 being turned to be fitted onto the panel chassis 24 can be avoided is formed in the front chassis 40 and the panel chassis 24. However, the present invention is not limited to this embodiment. Alternatively, the housing 14 may include a back chassis (so-called backlight chassis) as a second frame. In this case, a configuration with which damage to the flexible substrate 15 due to the front chassis 40 being turned to be fitted onto the back chassis can be avoided may be formed in the front chassis 40 and the back chassis. The panel 11 may be held between the front chassis 40 and the back chassis, or between the front chassis 40 and another panel chassis 24. In the case where the back chassis is used, the display apparatus 10 may further include a light source unit. The light source unit is disposed so as to face the light-receiving surface of the display panel 11 so that light from the light source unit travels toward the light-receiving surface of the display panel 11.

Thus, in the housing 14 configured such that the first frame 40 is turned to be fitted onto the second frame 24 as described herein, in the case where an attached member (e.g., the flexible film 15) attached to the housed object 11 housed inside the second frame 24 protrudes out of the second frame 24, then if the first frame 40 and the second frame 24 are provided with the features disclosed herein in order to avoid damage (preferably cleavage) to such an attached member, this configuration is within the scope of the present invention. The apparatus 10 in which the housed object 11 is housed in the housing 14 of the present invention is also within the scope of the present invention.

The technical features (constituent elements) described above may be combined together, and the resultant combinations may form new technical features.

It should be understood that the embodiments herein are illustrative in all respects and not restrictive. The scope of the invention is defined by the appended claims, and therefore, all changes that fall within metes and bounds of the claims, or equivalence of such metes and bounds thereof, are intended to be embraced by the claims.

### REFERENCE SIGNS LIST

10 display apparatus (apparatus)
11 display panel (housed object, panel)
111 image display region
112 peripheral region
14 housing
15 flexible substrate (flexible film)
24 panel chassis (second frame)
241 fixation portion
242 holding portion
32 notch
321 notch edge
35 through-hole
36 protrusion (fixation assisting mechanism)
40 front chassis (first frame)
41 frame portion (bottom plate portion)
42 side plate portion
421 first side plate portion
422 second side plate portion

1. A housing comprising:
a first frame including a rectangular bottom plate portion, and side plate portions provided along an outer perimeter edge of the bottom plate portion and perpendicular to the bottom plate portion; and
a second frame including a rectangular holding portion, and fixation portions each having an outer surface to abut outwardly with an inner surface of the corresponding one of the side plate portions of the first frame,
wherein the first frame is fitted onto the second frame with the bottom plate portion of the first frame facing the holding portion of the second frame,
a first one of the side plate portions of the first frame has a notch formed at an edge of the first side plate portion farther from the bottom plate portion of the first frame, and the notch has a notch depth increasing gradually in a direction from a far position toward a near position to a second one of the side plate portions adjacent to the first side plate portion, and
a plurality of the notches are formed in the first side plate portion, among which a rate at which the notch depth increases gradually becomes greater in the direction from the far position toward the near position.

2. (canceled)

3. The housing of claim 1, wherein
the first side plate portion is formed at both ends of the second side plate portion.

4. The housing of claim 1 wherein when a housed object in the shape of a rectangular parallelepiped is sandwiched between the first frame and the second frame and
when the first frame is fitted onto the second frame by the first frame being turned around a contact portion between the first frame and the second frame as a pivotal axis, a notch edge defining the notch depth of the notch comes in contact with a flexible film protruding out of the housed object, substantially simultaneously across its length from a closer end to a farther end relative to the pivotal axis.

5. The housing of claim 4, wherein
a fixation assisting mechanism for assisting in fixing the side plate portion of the first frame to the fixation portion of the second frame is formed in a region where the flexible film is not present.

6. An apparatus comprising:
the housing of claim 1; and
a housed object in the shape of a rectangular parallelepiped and sandwiched between the first frame and the second frame,
wherein a flexible film attached to a peripheral portion of an upper surface of the housed object facing the bottom plate portion of the first frame protrudes out of the housed object.

7. The apparatus of claim 6, further comprising:
a light source unit disposed so as to face a lower surface of the housed object parallel to the upper surface.
